(19) United States
(12) Patent Application Publication
(10) Pub. No.: US 2015/0123507 A1
(43) Pub. Date: May 7, 2015

(54) Electric Generator for Wind Power Installation

(71) Applicants: Vladimir Grigorievich DEGTYAR, Miass (RU); Vladimir Pavlovich Krivospitsky, Miass (RU); Valery Mikhailovich Kuznetsov, Miass (RU); Vasily Filippovich Maksimov, Miass (RU)

(72) Inventors: Vladimir Grigorievich DEGTYAR, Miass (RU); Vladimir Pavlovich Krivospitsky, Miass (RU); Valery Mikhailovich Kuznetsov, Miass (RU); Vasily Filippovich Maksimov, Miass (RU)

(21) Appl. No.: 14/071,854

(22) Filed: Nov. 5, 2013

(51) Int. Cl. H02K 1/27; H02K 3/12

(52) U.S. Cl. CPC H02K 1/2793; H02K 3/12
USPC 310/156.37; 310/156.38; 310/208

(57) ABSTRACT

An electric generator for windmill installations has a simple and efficient design, including a stator having a coil, a rotor having a base, a lid, and magnets. Rotor magnets are arranged on the lid and base along an annular line with a predetermined gap, and the coil, fixed by ring-shaped plates on both sides thereof, is mounted between the magnets with a minimal gap. The gap between the ring-shaped plates and the magnets is filled up with magnetic liquid. The coil is formed of three windings, located in radial grooves of a matrix, including outer and inner parts. The ring-shaped plates and matrix are made of dielectric non-magnetic material, the base and lid are made of magnetic-flux conductive material. The poles of adjacent magnets on the base and lid have opposite polarities. The poles of magnets mounted on the base face the magnets mounted on the lid with opposite polarities.

### FIELD OF THE INVENTION

The invention relates to electric engineering, usable for electric power generation in installations with low RPM, particularly in windmills with a vertical rotational axis.

### BACKGROUND OF THE INVENTION

There are known wind power installations with electrical generators (see references [R1]-[R6] at the end of present description).

According to the invention described in an invention [1], a gearless windmill with a vertical axis of rotation comprises a rotor with vertical blades, the rotor is mounted on bearing support members configured as a torus. Electromagnets and inductors are located symmetrically in relation to a vertical axis of each cross-section of the torus.

A drawback of such an invention is complexity of its structure, and difficulties for employment thereof for generating significant electric power.

An electric machine, being more relevant to the proposed invention, is described in [R6]. It comprises a group of stator windings represented by two snake-like coils, each such coil moves along a curved circuit segment. In each such segment that forms a stator winding section, electric current is generated in a separate phase. The snake-like coils embrace plates supplied with magnets.

A drawback of such design is complexity in manufacturing, since the snake-like coils are produced with a slot gap, wherein magnets are situated. For increasing an efficiency of the generator, the gaps should be minimal, which is difficult to provide, since the gap is formed by a wisp of wires.

Besides, in such arrangement of windings, magnetic flux is wasted, since magnetic lines are circulated within a big air gap; an electric phase angle of 120° between the stator windings is also difficult to provide.

### OBJECT AND BRIEF SUMMARY OF THE INVENTION

Therefore, the object of the present invention is to design an electric generator of a simple structure with high efficiency.

This object is achieved by a distinct design of coil windings having an annular shape; the coil is made as one whole, preferably having a flat configuration with two sides, wherein the coil is depressed by ring-shaped plates on each aforesaid side; while rotor magnets are arranged above and under the said windings

In a preferred embodiment, the inventive electric generator comprises:
a rotor including: a base; a lid; and
a plurality of rotor magnets mounted on the base and the lid and arranged along an annular line;
a stationary stator including: a matrix having an outer part and an inner part, forming a plurality of radial grooves therebetween;
a flat stator coil having a diameter at least 50 times greater than the height thereof; the flat stator coil is situated between the rotor magnets with predetermined gaps; the flat stator coil is formed of three stator windings; said stator windings each is placed in the radial grooves of the stator matrix; and wherein the flat stator coil is fixed with ring-shaped plates on both sides thereof.

### BRIEF DESCRIPTION OF DRAWINGS

The substance of the present invention is illustrated by the following drawings:

FIG. 1 shows a general view of the electric generator.

FIG. 2 shows a fragmentary sectional view of the electric generator;

FIG. 3 shows a plan view of the electric generator;

FIG. 4 shows a view of the generator stator from the above;

FIG. 5 shows a view of the stator coil assembled;

FIG. 6 shows a view of a winding of one phase of the coil in the matrix;

FIG. 7 shows a view of a matrix assembled;

FIG. 8 shows a view of the matrix outer part;

FIG. 9 shows a view of the matrix inner part;

FIG. 10 shows a sectional view of the electric generator with an air gap filled up with magnetic liquid.

### DETAIL DESCRIPTION OF PREFERRED EMBODIMENTS OF THE INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as exemplified herein.

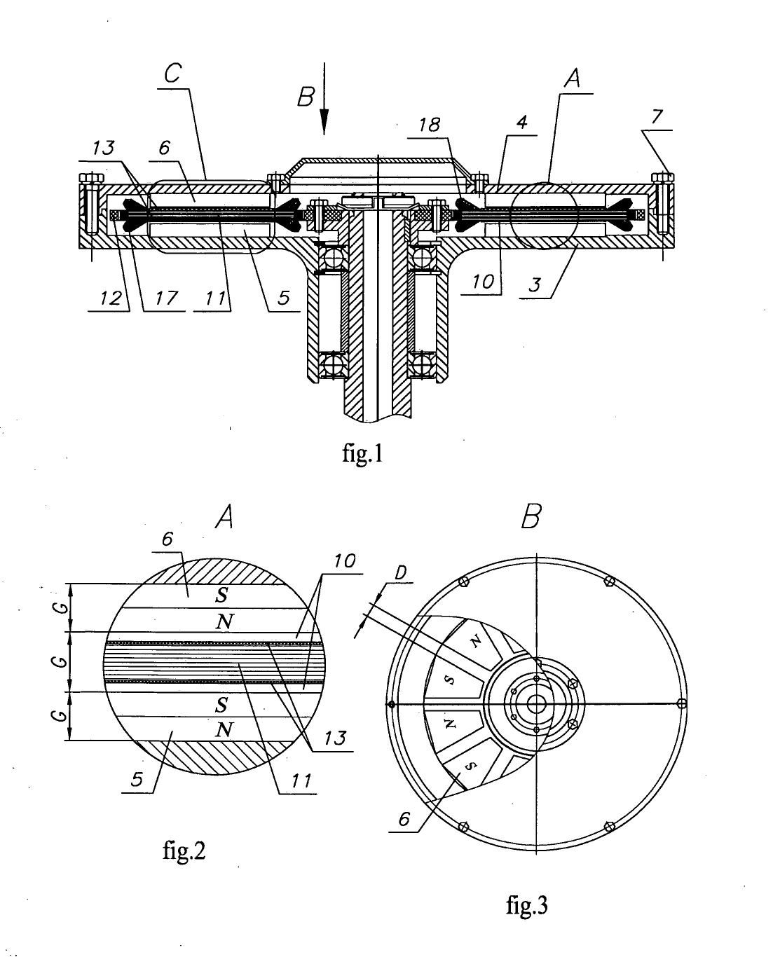

The inventive electric generator includes a rotor 1 and a stator 2. The rotor 1 comprises: a base 3 and a lid 4; magnets 5 and 6 (herein also referred to as ‘rotor magnets’) are rigidly mounted on the base 3 and the lid 4 respectively. The base 3 and the lid 4 are made of magnetic-flux conductive material, and joined with bolts 7. The magnets 5 are arranged on the base 3, and the magnets 6 are arranged on the lid 4 strictly one against the other (see FIG. 1, 2) with opposite poles facing each other. The magnets 5 and 6 are mounted on the base 3 and the lid 4 along an annular line, wherein the opposite poles of the magnets take turns (see FIG. 3).

The magnets 5 and 6 are mounted on the base 3 and the lid 4 so that an air gap whose width equals to a radial gap D (see gap D in FIG. 3,7,8,9). The magnets 5 and 6 have a height equal to a distance G between the magnets in the rotor when assembled (see FIG. 2). The magnets 5 and 6 are configured as a trapezium in the plan projection view (see FIG. 3).

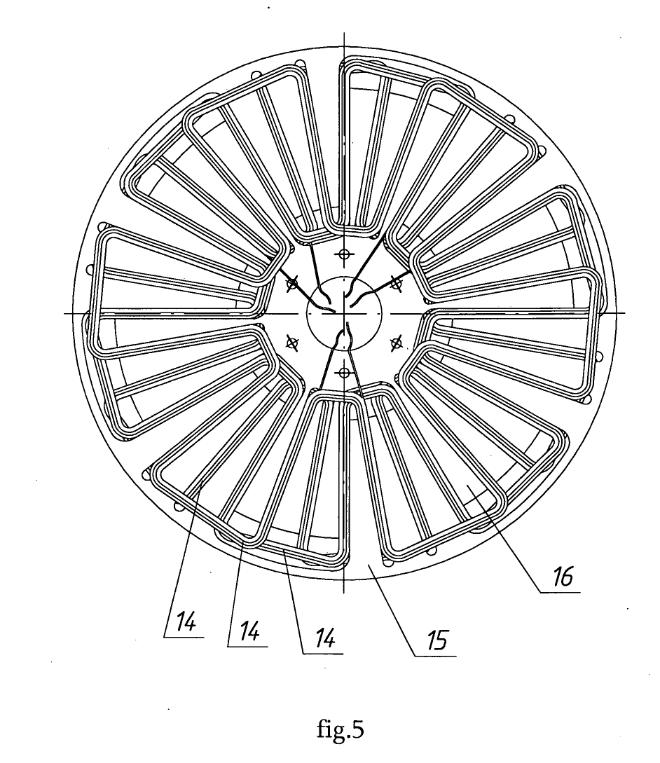

The stator 1 comprises a flat three-phase wire coil mounted between the magnets 5 and 6 separated by an air gap 10 (see FIG. 2). The coil 11 is placed in a matrix 12 including a plurality of grooves; the coil 11 is depressed by two ring-shaped dielectric plates 13. The coil 11 includes three identical annular windings 14 (herein also referred to as ‘stator windings’), placed in the grooves of matrix 12 (see FIG. 5).

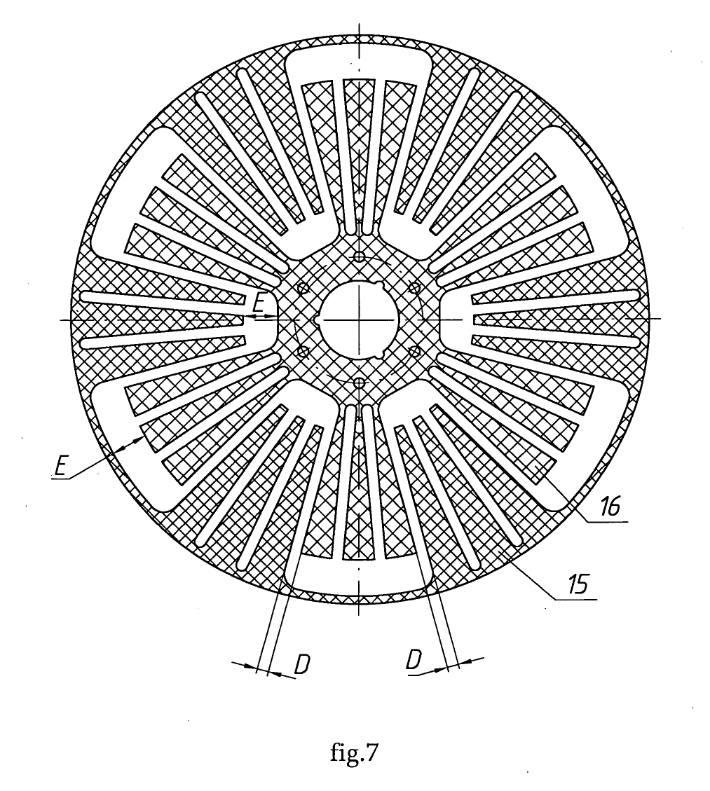

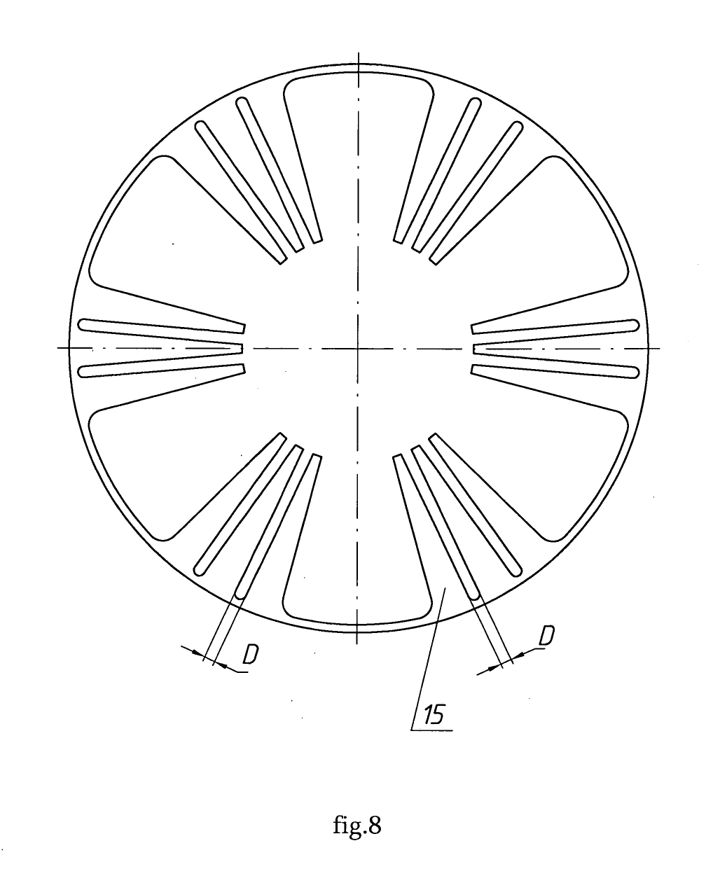

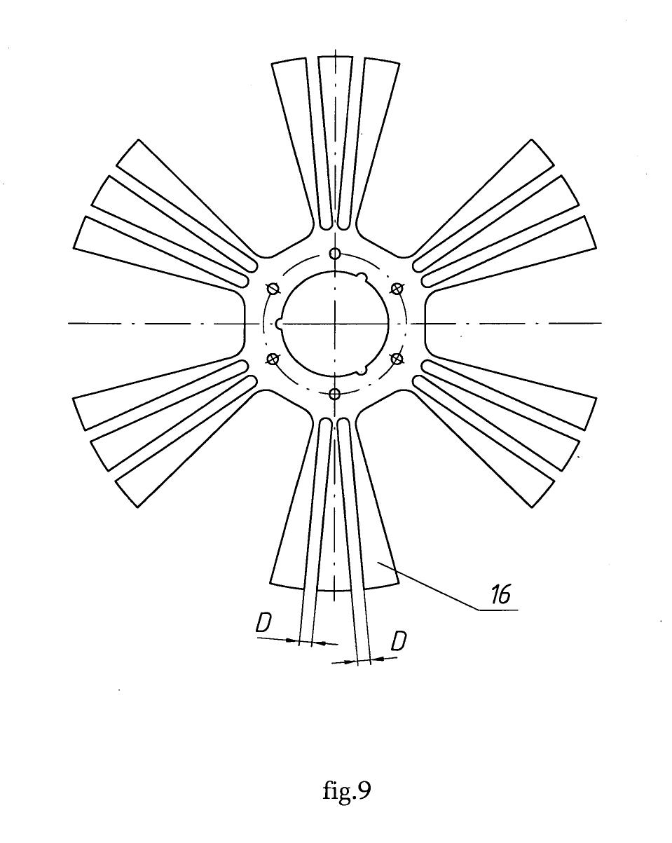

The matrix 12 comprises two parts: an outer matrix part 15, and an inner matrix part 16 made of dielectric material. The inner part 15 and outer part 16 are configured with identical radial grooves having a width D; when the parts 15 and 16 are interposed, gaps are formed between the inner and outer matrix parts, having a width equal to D as well. Besides, when the parts 15 and 16 are assembled, gaps are formed therebetween, having a width E (see FIG. 7,8,9).

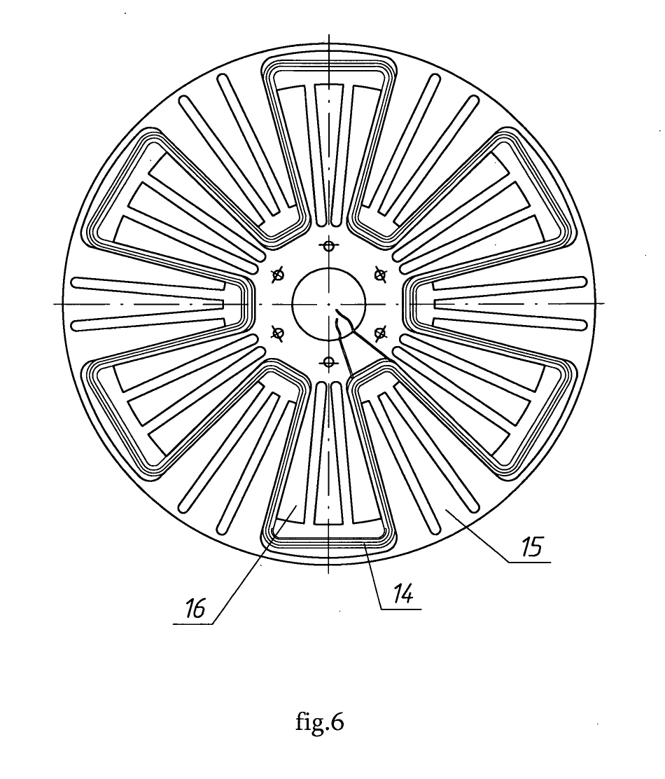

The first winding 14 is disposed in the matrix plain in the gaps D and E (see FIG. 6). The second winding 14 and the third winding 14 are inserted in the gaps D and in the vicinity of gaps E; they both have bents 17 on the outer part, and bents 18 on the inner part of the respective winding (see FIG. 1,5).

The generator is assembled as follows. The windings 14 are made of wires of equal length. Each winding 14 is placed in the next grooves D of assembled matrix 12. Thus, the windings 14 are located in the uniformly positioned grooves with an equal width D, which provides for a uniformed phase electric angle of 120° between the windings 14 of coil 11 (see FIG. 5).

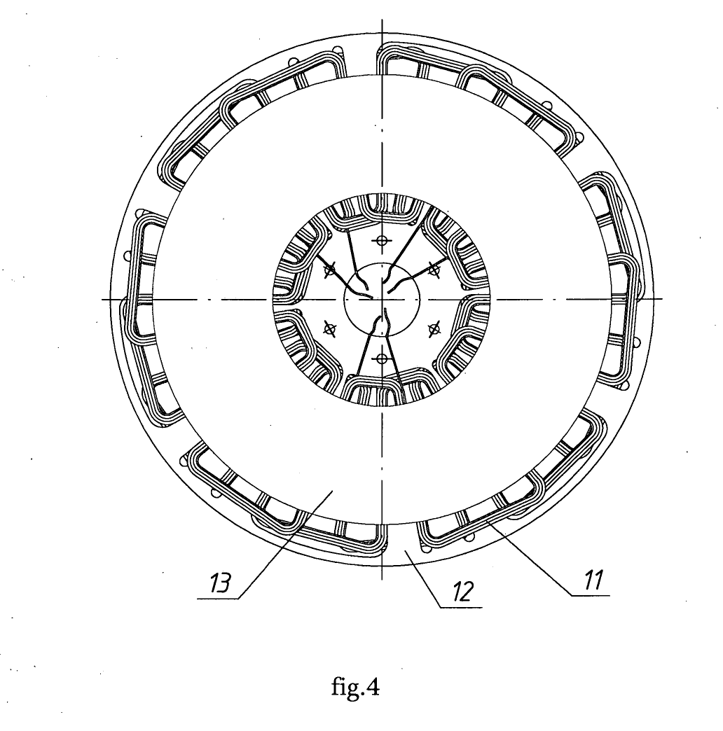

For increasing the density of wires so that the wires do not outstand from the common surface the windings 14 are depressed on both sides by the ring-shaped plates 13 , the the said plates preferably coupled with glue under pressure, thereby providing a dense placement of the windings 14 that in turn provides for a uniformed gap 10 between the magnets 5, 6 and coil 11 (see FIG. 4).

The so assembled coil 11 is mounted in the stator 2, providing a minimum possible air gap 10 between the magnets 5 and plates 13; then the lid 4 with magnets 6 are mounted, observing the same air gap 10; thereafter the lid 4 is secured by bolts 7 (see FIG. 1,2).

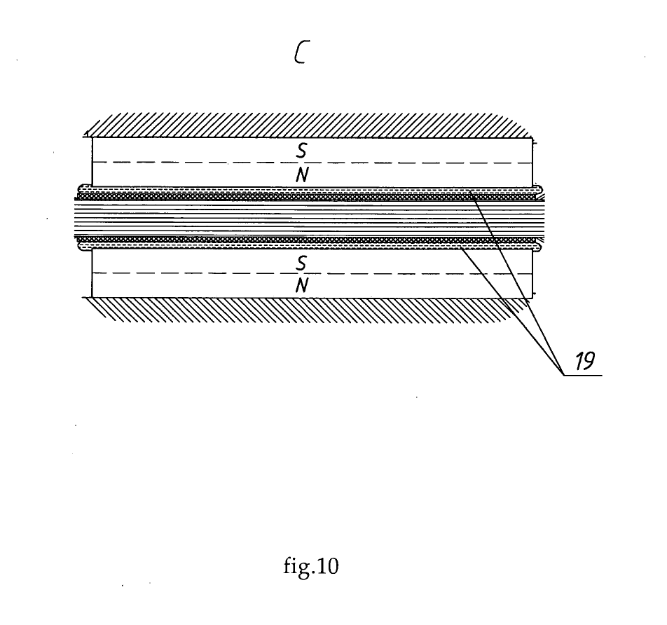

For increasing the magnetic flux, the air gap 10 is filled up by magnetic liquid 19 (see FIG. 10). This provides for a maximum possible magnetic flux via the stator windings 14, since the windings practically contact the rotor magnets 5 and 6 gaplessly.

As a result of the increase of magnetic flux, the electro-motive force (EMF) of the stator windings 14 magnifies according to the formula below:

ξ=B·V·L

wherein: ξ is an EMF of the coil;

B is a magnetic flux;

V is a linear speed of a wire in the magnetic flux;

L is a length of the wire extending within an area of the magnetic flux.

Due to the disposition of magnets 5 and 6, there is provided a confined magnetic flux via the lid 4 and base 3; wherein, upon the windings of coil 11 are crossing the magnetic flux, an alternative three-phase current with an electric phase angle of 120° is induced within the windings 14. As a rule, this allows connecting windings of the coil 11 into a <<star>> or a <<triangle>> to further transfer the generated electric power to a consumer.

Thusly, the invention achieves the following results:
simple design;
gain of efficiency due to the absence of Foucault eddy currents in the coil during re-magnetizing, because the coil has no ferromagnetic; and
magnifying the EMF in the stator windings due to filling up the gap between the stator and rotor by magnetic liquid.

### REFERENCES

[R1] Russian Federation Patent RU 2 037 070 having priority as of 13 Mar. 1992;

[R2] Russian Federation Patent RU 2 064 082 having priority as of 16 Feb. 1993;

[R3] Russian Federation Patent RU 2 203 434 having priority as of 15 Mar. 2000;

[R4] Russian Federation Patent RU 2 203 434 having priority as of 19 Sep. 2006;

[R5] Russian Federation Patent RU 80 516 U1 having priority as of 11 Sep. 2008;

[R6] U.S. Pat. No. 7,646,132 issued on 12 Jan. 2010.

What is claimed is:

1. An electric generator for a windmill power installation, comprising:
a rotor including:
a base;
a lid;
a plurality of rotor magnets mounted on the base and the lid and arranged along an annular line;
a stationary stator including:
a matrix having an outer part and an inner part, forming a plurality of radial grooves therebetween;
a flat stator coil situated between the rotor magnets with predetermined gaps; wherein said stator coil is formed of three stator windings, said stator windings each is placed in the radial grooves; said flat stator coil is fixed with ring-shaped plates on both sides thereof, and wherein the ring-shaped plates and the matrix are made of dielectric non-magnetic material.

2. The electric generator according to claim 1, wherein said rotor magnets each further includes two poles with opposite polarities; and said rotor magnets are such disposed that the poles of two adjacent said rotor magnets, mounted on the base or on the lid, have opposite polarities; and
wherein the corresponding rotor magnets disposed on the lid and on the base face each other with the poles of opposite polarities.

3. The electric generator according to claim 1, wherein said radial grooves are equidistantly located along a circular line, and have identical dimensions.

4. The electric generator according to claim 2, wherein the base and lid are made of magnetic material.

5. The electric generator according to claim 2, wherein said rotor magnets are shaped as a trapezium in a plan projection view.

6. The electric generator according to claim 5, wherein said predetermined gaps are formed by said radial grooves of equal dimensions.

7. The electric generator according to claim 5, wherein the rotor magnets, disposed on the lid and on the base, have a predetermined distance therebetween; each of said rotor magnets has a height; and wherein the predetermined distance is equal to the height.

8. An electric generator for a windmill power installation, comprising
a rotor including:
a base;
a lid;
a plurality of rotor magnets mounted on the base and the lid and arranged along an annular line;
a stationary stator including:
a flat stator coil situated between the rotor magnets;
wherein:
said stator coil is fixed with ring-shaped plates on both sides thereof, said ring-shaped plates and said rotor magnets form a predetermined gap space therebetween, and said predetermined gap space is filled up with magnetic liquid.
